(19) United States
(12) Patent Application Publication
(10) Pub. No.: US 2006/0222857 A1
(43) Pub. Date: Oct. 5, 2006

(54) Individual flexible dry erase pads

(76) Inventor: Joseph A. Haas, Norton, OH (US)

Correspondence Address: JOSEPH A HAAS, 2645 HAMETOWN RD, NORTON, OH, 44203, US

(21) Appl. No.: 11/367,493

(22) Filed: Mar. 4, 2006

Related U.S. Application Data
(60) Provisional application No. 60/664,971, filed on Mar. 24, 2005.

(51) Int. Cl. B32B 27/38

(52) U.S. Cl. 428/413

(57) ABSTRACT

A dry erase pad made of a transparent dry erase film top layer for allowing dry erase marker markings to be wiped off. Prior to application of the dry erase layer, the opaque vinyl layer of the flexible substrate may be printed on directly with a layout or design for a specific use.

This patent takes the benefit of provisional patent No. 60/664,971 dated Mar. 24, 2005.

### BRIEF SUMMARY OF THE INVENTION

A dry erase pad made of a flexible substrate that may have a printed layout or design and a transparent dry erase film is applied for the top layer. This dry erase film layer with adhesive backing is applied to flexible magnet substrate to allow for dry erase marker markings and wiped off.

### DETAILED DESCRIPTION OF THE INVENTION

A dry erase pad made of a transparent dry erase film top layer for allowing dry erase marker markings to be wiped off. The dry erase film layer with adhesive backing is applied to a flexible substrate (for one example a vinyl banner type material). Prior to application of the dry erase layer, the opaque vinyl layer of the substrate may be printed on directly with a layout for a specific use. Just to name a few examples such as lettering lines, music lines, coaches layouts, games, charts, words, symbols, diagrams; versatile for any kind of application). The pads may be used individually or used as a kit for a specific purpose with a group.

These individual pads can be any size and be rectangular or cut to a specific shape. The pads may be used individually or in kits. They would provide a means for multiple markings with a writing device such as a dry erase marker and erasings without the need for paper. Thus giving the user a flexible dry erase pad capability.

### REFERENCES CITED

Examples of past dry erase boards may be found in several prior art patents, such as

U.S. Pat. No. 6,647,652

U.S. Pat. No. 6,272,779

U.S. Pat. No. 6,263,602

U.S. Pat. No. 5,527,568

U.S. Pat. No. 5,655,323

U.S. Pat. No. 5,658,635

U.S. Pat. No. 5,948,498

However, all these patents have the use of a rigid board for the backing substrate which has limits on transport and storage.

Another example of dry erase patent is U.S. Pat. No. 5,741,561 which describes the use of a double walled placemat with a clear top sheet provided with one or more sides open for inserting a piece of paper in the pocket. This invention still relies on the use of a piece of paper as the insert. The present patent utilizes a stationary printed format that can be marked on over and over due to the dry erase film surface.

### DESCRIPTION OF THE DRAWING

The following drawing page (Page 1 of 1) is as described below:

FIG. 1A. The substrate is made of a flexible backing material.
1. The substrate may be opaque (One example is a vinyl banner material).
2. The substrate may be transparent for allowing overlay of existing surfaces.
3. The substrate may or may not be direct printed with a design or layout.

FIG. 1B. The top layer is made of a transparent film with an adhesive backing for attaching to the substrate layer.

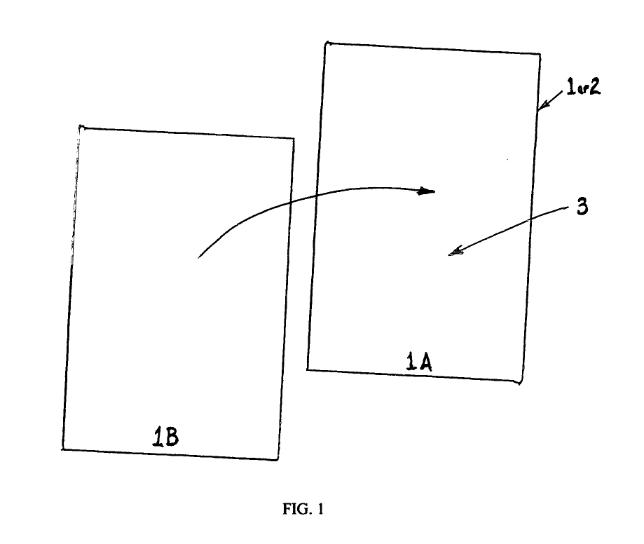

1. It is the object of the present invention to provide a flexible dry erase surface which has no frame, board or rigid substrate which does not allow the ease of transport or storage that the invention's thinner, flexible substrate allows.

2. Per claim 1, another object is to provide a portable, stack-able, roll-able pad surface for dry erase marking.

3. Another object is to provide a flexible substrate with an opaque vinyl top layer which can have a layout or design directly printed on the surface. A couple of examples of direct printing processes are screen printing, inkjet printing or flatbed printing.

4. Per claim 3, another object is the design of the printed layout or designs to allow for the user to take advantage of not having to draw/write repetitive items. An example of this could be an aid for informational, educational, or instructional uses such as lettering lines for writing, chart form for logging information, layouts for sports fields, educational layouts or designs, games and other layouts or designs.

5. Per claim 3, another object is that any layouts or designs that are printed on the flexible substrate can be customized for many different activities for different levels.

6. Per claim 3, another object is that these many varieties of layouts or designs may be used for many different educational, instructional, entertainment or other fields of employment.

7. Another object is to provide the opportunity to use the dry erase pad in lieu of writing on a dry erase board or other blackboard surfaces which will provide multiples uses. The hand writing type system only allows for one time use and remarking after erased.

8. Per claim 7, another object is that the flexible substrate allows for applying to other surfaces for uses where a dry erase board is not available. One example is having the dry erase layer applied to a flexible substrate such as a static cling material which may or may not be printed with design or layout. This allows for use due to its portability which can be applied to windows, vertical metal surfaces or even other dry erase boards.

9. Per claim 7, another object is that the existing dry erase board has multiple materials & several steps to manufacture in lieu of present patent of printing on substrate & adding a dry erase layer.

10. Per claim 7, the entire pad may be displayed on a vertical surface. Examples may be adding a magnetic strip, Velcro strip, adhesive, strip, clip, matt, grommet, or hook attachment.
It is understood that the present invention is not limited to the embodiments of any examples given in this application.
